(19) United States
(12) Patent Application Publication
(10) Pub. No.: US 2018/0349129 A1
(43) Pub. Date: Dec. 6, 2018

(54) APPARATUS FOR SUPPORTING FIRMWARE UPDATE AND METHOD FOR THE SAME

(71) Applicant: ELECTRONICS AND TELECOMMUNICATIONS RESEARCH INSTITUTE, Daejeon (KR)

(72) Inventors: Hong-Il JU, Daejeon (KR); Young-Ho KIM, Daejeon (KR); Yun-Kyung LEE, Daejeon (KR); Bo-Heung CHUNG, Daejeon (KR); Jeong-Nyeo KIM, Daejeon (KR); Jae-Deok LIM, Sejong (KR); Yong-Sung JEON, Daejeon (KR)

(21) Appl. No.: 15/944,629

(22) Filed: Apr. 3, 2018

(30) Foreign Application Priority Data
Jun. 1, 2017 (KR) 10-2017-0068450

(51) Int. Cl. G06F 8/654

(52) U.S. Cl. CPC G06F 8/654

(57) ABSTRACT

Disclosed herein is an apparatus for providing firmware update, which includes a state information analysis unit for analyzing device state information received from a firmware update target device and thereby acquiring information about a version of existing firmware and information about a storage unit of the firmware update target device; an image creation unit for creating a delta image in units of pages based on a flash memory page size included in the information about the storage unit and on a difference between the existing firmware and new firmware; an update information creation unit for creating update information in which an update method is specified; and a communication unit for transmitting the update information and the delta image to the firmware update target device in order to update the existing firmware of the firmware update target device based on the update method.

### CROSS REFERENCE TO RELATED APPLICATION

This application claims the benefit of Korean Patent Application No. 10-2017-0068450, filed Jun. 1, 2017, which is hereby incorporated by reference in its entirety into this application.

### BACKGROUND OF THE INVENTION

### 1. Technical Field

The present invention relates to an apparatus and method for supporting update of firmware of IoT devices having limited hardware resources.

### 2. Description of the Related Art

The present invention relates to a method for securely and efficiently updating the firmware of lightweight smart devices without user intervention in a remote manner when necessary. In the Internet of Things (IoT) environment, in which objects are connected over the internet, a Firmware Over The Air (FOTA) service, through which the firmware of smart devices can be wirelessly updated, is currently used. These days, most smart devices update their firmware to the latest version of firmware using such a FOTA service when necessary.

In the IoT environment, various kinds of smart devices are connected. Because these smart devices have different performance and hardware resources, different update methods may be used depending on the performance and the hardware resources.

For example, mobile devices, such as smartphones, have high-performance hardware and ample resources and provide smooth network connectivity. Accordingly, an entire firmware image to be used for update may be downloaded to a target device, and then the firmware thereof may be updated. However, recently, a delta update method, in which only the difference between the existing version of a firmware image and the new version thereof is transmitted and used for update, is used. This method is intended to minimize the amount of data to be transmitted because most smart devices are battery-powered devices and are connected over a wireless network. Also, an update file is created and then compressed before being transmitted in order to reduce the amount of data to be transmitted.

When the existing delta update method is applied to a low-specification smart device, the low-specification device is required to create a new firmware image by comparing the received delta image with the existing firmware image. If the low-specification device has memory space sufficient to create and store a new firmware image, the existing delta update method may be applied without change, but if not, a new update method is required.

Also, required is an update method for providing the function of rolling back to a previous firmware version or resuming an interrupted update process when an error occurs during the update process due to the interruption of supply of power or other reasons.

### DOCUMENTS OF RELATED ART

### (Patent Document 1) Korean Patent No. 10-1019822.

### SUMMARY OF THE INVENTION

An object of the present invention is to provide an apparatus and method for supporting firmware update that provide firmware update using a page-based delta image, which is created based on a page size of flash memory in a target device, the firmware of which is to be updated.

Another object of the present invention is to provide an apparatus and method for supporting firmware update that provide firmware update suitable for the state of the hardware resources of a target device, the firmware of which is to be updated.

A further object of the present invention is to provide an apparatus and method for supporting firmware update in which, when firmware update is interrupted, an update may be resumed from the point at which the update was interrupted, or firmware may be restored to the state before the update.

An embodiment of the present invention provides an apparatus for providing firmware update, which includes a state information analysis unit for analyzing device state information received from a firmware update target device and thereby acquiring information about a version of existing firmware and information about a storage unit of the firmware update target device; an image creation unit for creating a delta image in unit of pages based on a flash memory page size included in the information about the storage unit and on a difference between the existing firmware and new firmware; an update information creation unit for creating update information in which an update method is specified; and a communication unit for transmitting the update information and the delta image to the firmware update target device in order to update the existing firmware of the firmware update target device based on the update method.

Here, the update method may be selected from among an overwrite-based update method, in which an existing firmware image is overwritten with a new firmware image, and a copy-based update method, in which the existing firmware image is not overwritten with the new firmware image.

Here, the copy-based update method may be configured such that the new firmware image is written from a last page thereof to a new area of the storage unit of the firmware update target device; and the overwrite-based update method may be configured such that the new firmware image is written from the last page thereof to an area in which the existing firmware image is stored in the storage unit of the firmware update target device after pages to be overwritten with the new firmware image due to update, among pages included in the existing firmware image, are backed up in the new area of the storage unit of the firmware update target device.

Here, the copy-based update method and the overwrite-based update method may be configured to store update status information while firmware update is in progress and to use the update status information to resume firmware update from a page that was processed at a time of interruption or to revert to a state before update when firmware update is interrupted.

Here, the copy-based update method may be used when an amount of free space remaining in the storage unit of the firmware update target device is sufficient to store an image corresponding to the new firmware; and the overwrite-based update method may be used when the amount of free space remaining in the storage unit of the firmware update target device is insufficient to store the image corresponding to the new firmware.

Here, the image creation unit may create multiple partial delta images, each of which has a size corresponding to the amount of the free space, when the amount of the free space remaining in the storage unit of the firmware update target device is insufficient to store the delta image; and the communication unit may transmit the update information and each of the partial delta images to the firmware update target device in order to update the existing firmware of the firmware update target device based on the update method.

Here, the update information may include information for identifying the firmware update target device, new firmware version information, and the update method, and may further include delta information, which includes one or more of a total number of pages included in the delta image, a number of pages to be modified, page numbers of the pages to be modified, a location of data to be modified, a length of the data to be modified, a number of pages to be added, page numbers of the pages to be added, a length of data on a last page to be added, and an integrity verification value.

Another embodiment of the present invention provides a firmware update target device, which includes a communication unit for transmitting device state information to a firmware update provision apparatus in order to enable the firmware update provision apparatus to acquire information about a version of existing firmware and information about a storage unit by analyzing the device state information and for receiving a delta image and update information, in which an update method is specified, from the firmware update provision apparatus, the delta image being created in units of pages based on a flash memory page size, which is included in the information about the storage unit, and on a difference between the existing firmware and new firmware; and an update unit for updating firmware using the delta image based on the update method.

Here, the update method may be selected from among an overwrite-based update method, in which an existing firmware image is overwritten with a new firmware image, and a copy-based update method, in which the existing firmware image is not overwritten with the new firmware image.

Here, the copy-based update method may be configured such that the new firmware image is written from a last page thereof to a new area of the storage unit; and the overwrite-based update method may be configured such that the new firmware image is written from the last page thereof to an area in which the existing firmware image is stored in the storage unit after pages to be overwritten with the new firmware image due to update, among pages included in the existing firmware image, are backed up in the new area of the storage unit.

Here, the update unit may store update status information; and when update is interrupted, the update unit is capable of resuming update from a page that was processed at a time of interruption or of reverting to a state before the update using the update status information.

Here, the copy-based update method may be used when an amount of free space remaining in the storage unit is sufficient to store the new firmware image; and the overwrite-based update method may be used when the amount of the free space remaining in the storage unit is insufficient to store the new firmware image.

Here, the communication unit may sequentially receive partitioned delta images, each of which is created by the firmware update provision apparatus so as to have a size corresponding to the amount of the free space remaining in the storage unit because the amount of the free space is insufficient to store the delta image; and the update unit may sequentially perform partial update using the partitioned delta images, thereby completing full update.

Here, the update information may include information for identifying the firmware update target device, new firmware version information, and the update method, and may further include delta information, which includes one or more of a total number of pages included in the delta image, a number of pages to be modified, page numbers of the pages to be modified, a location of data to be modified, a length of the data to be modified, a number of pages to be added, page numbers of the pages to be added, a length of data on a last page to be added, and an integrity verification value.

A further embodiment of the present invention provides a firmware update method, which includes transmitting device state information to a firmware update provision apparatus in order to enable the firmware update provision apparatus to acquire information about a version of existing firmware and information about a storage unit by analyzing the device state information; receiving a delta image and update information, in which an update method is specified, from the firmware update provision apparatus, the delta image being created in units of pages based on a flash memory page size, which is included in the information about the storage unit, and on a difference between the existing firmware and new firmware; and updating firmware using the delta image based on the update method.

Here, the update method may be selected from among an overwrite-based update method, in which an existing firmware image is overwritten with a new firmware image, and a copy-based update method, in which the existing firmware image is not overwritten with the new firmware image.

Here, the copy-based update method may be configured such that the new firmware image is written from a last page thereof to a new area of the storage unit; and the overwrite-based update method may be configured such that the new firmware image is written from the last page thereof to an area in which the existing firmware image is stored in the storage unit after pages to be overwritten with the new firmware image due to update, among pages included in the existing firmware image, are backed up in the new area of the storage unit.

Here, updating the firmware may be configured to store update status information, and when update is interrupted, the update status information is used to resume update from a page that was processed at a time of interruption or to revert to a state before the update.

Here, the copy-based update method may be used when an amount of free space remaining in the storage unit is sufficient to store the new firmware image; and the overwrite-based update method may be used when the amount of free space remaining in the storage unit is insufficient to store the new firmware image.

Here, the update information may include information for identifying the firmware update target device, new firmware version information, and the update method, and may further include delta information, which includes one or more of a total number of pages included in the delta image, a number of pages to be modified, page numbers of the pages to be modified, a location of data to be modified, a length of the data to be modified, a number of pages to be added, page numbers of the pages to be added, a length of data on a last page to be added, and an integrity verification value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows the configuration of a firmware update system according to an embodiment of the present invention;

FIG. 2 is a view that shows an example of the operation process of the firmware update system illustrated in FIG. 1;

FIG. 3 is a block diagram that shows an apparatus for providing firmware update according to an embodiment of the present invention;

FIG. 4 is a block diagram that shows a firmware update target device according to an embodiment of the present invention;

FIG. 5 is a flowchart that shows a firmware update method according to an embodiment of the present invention;

FIG. 6 is a flowchart that shows an example of the step (S507) of creating update information, illustrated in FIG. 5;

FIG. 7 is a flowchart that shows an example of the step (S601) of selecting an update method, illustrated in FIG. 6;

FIG. 8 is a flowchart that shows a firmware update method according to an embodiment of the present invention;

FIG. 9 is a flowchart that shows an example of the step (S805) of performing update, illustrated in FIG. 8;

FIG. 10 is a view that shows an example of firmware images in flash memory, which are configured with pages;

FIG. 11 is a view that shows an example of the structures of update status information, update information, and a delta image;

FIG. 12 is a view that shows an update process using a copy-based update method for the example illustrated in FIG. 9; and

FIGS. 13 to 18 are views that show an update process using an overwrite-based update method for the example illustrated in FIG. 9.

### DESCRIPTION OF THE PREFERRED EMBODIMENTS

The present invention may be variously changed, and may have various embodiments, and specific embodiments will be described in detail below with reference to the attached drawings. The effects and features of the present invention and methods of achieving them will be apparent from the following exemplary embodiments, which will be described in more detail with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

However, the present invention is not limited to the embodiments to be described below, and all or some of the embodiments may be selectively combined and configured, so that the embodiments may be modified in various ways. It will be understood that, although the terms “first,” “second,” etc. may be used herein to describe various elements, these elements are not intended to be limited by these terms. These terms are only used to distinguish one element from another element. Also, a singular expression includes a plural expression unless a description to the contrary is specifically pointed out in context. Also, it should be understood that terms such as “include” or “have” are merely intended to indicate that features, components, parts, or combinations thereof are present, and are not intended to exclude the possibility that one or more other features, components, parts, or combinations thereof will be present or added.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

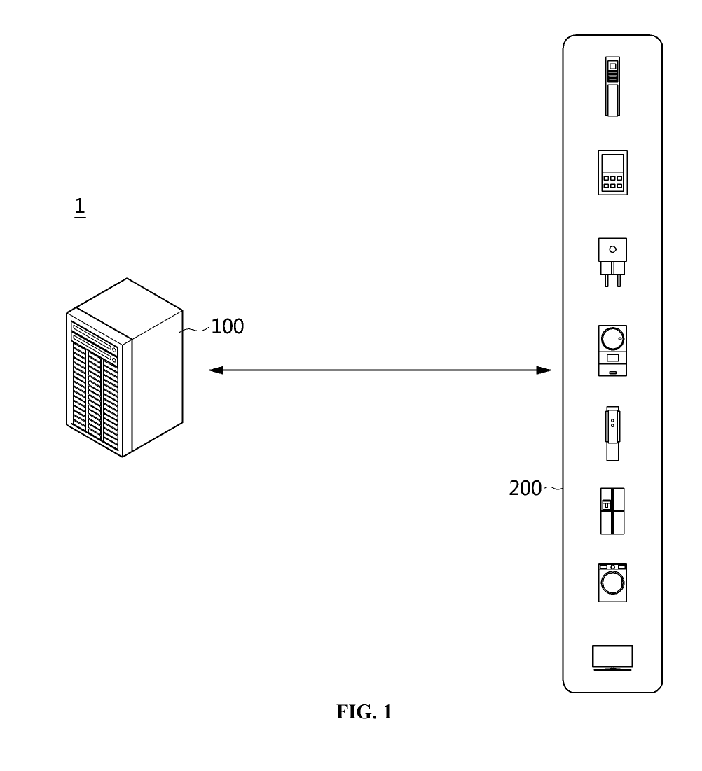

FIG. 1 is a view that shows the configuration of a firmware update system 1 according to an embodiment of the present invention.

Referring to FIG. 1, in the firmware update system 1 according to an embodiment of the present invention, an apparatus 100 for providing firmware update is interconnected with a target device 200, the firmware of which is to be updated, using a communication function.

Here, the communication function includes wired and wireless communication methods, and wireless communication methods may include Wi-Fi, ZigBee, Bluetooth Low Energy (BLE), and the like.

Here, the target device, the firmware of which is to be updated, may be directly connected with an update server for supporting update over a network, or may be connected therewith via a gateway.

Here, the firmware update provision apparatus 100 may be an update server for supporting update, or may be a gateway between the firmware update target device 200 and the update server.

The firmware update provision apparatus 100 according to an embodiment of the present invention receives device state information from the firmware update target device 200, acquires information about the version of existing firmware and information about the storage unit of the firmware update target device 200 by analyzing the device state information, creates a page-based delta image based on a flash memory page size, which is included in the information about the storage unit, and on the difference between existing firmware and new firmware, creates update information in which an update method is specified, and transmits the delta image and the update information to the firmware update target device 200, whereby the firmware update target device 200 updates the existing firmware based on the update method.

In the present invention, the target device is a device in which the storage area for storing and running firmware is flash memory, and in consideration of the characteristics of flash memory, an update method using a page-based delta image is provided.

Generally, flash memory is configured with multiple pages, and data can be written after being erased in units of pages. For example, in order to write one byte of data to flash memory, the entire page to which the data is to be written must first be erased.

Also, it may be assumed that a secure communication channel between the firmware update provision apparatus 100 and the firmware update target device 200 is established as the result of mutual authentication therebetween before a firmware update process. Even when an intermediate device, such as a gateway, is included, it may be assumed that secure communication channels are established as the result of mutual authentication between a low-specification device and the gateway and mutual authentication between the gateway and an update server.

For example, a secure communication channel may be established using a secure communication protocol, such as Transport Layer Security/Datagram Transport Layer Security (TLS/DTLS), depending on the performance and the security level of the firmware update target device 200. When such a secure communication protocol cannot be used, a secure communication channel may be established by performing mutual authentication using a previously shared secret key (secret information). However, the present invention does not include a mutual authentication process.

In an alternative embodiment, when deciding upon an update method, the firmware update provision apparatus 100 may select either an overwrite-based update method, in which an existing firmware image is overwritten with a new firmware image, or a copy-based update method, in which the existing firmware image is not overwritten with the new firmware image.

In an alternative embodiment, the copy-based update method may be configured such that a new firmware image is written from the last page thereof to a new area of the storage unit of the firmware update target device, and the overwrite-based update method may be configured such that the new firmware image is written from the last page thereof to the area in which the existing firmware image is stored in the storage unit of the firmware update target device after the pages to be overwritten with the new firmware image due to the update, among pages included in the existing firmware image, are backed up in the new area of the storage unit of the firmware update target device.

In an alternative embodiment, update status information is stored when update is performed in the firmware update target device 200. Accordingly, when update is later resumed after being interrupted, update may be resumed from the page that was processed at the time of interruption using the update status information.

In an alternative embodiment, meta information may include the total number of pages included in a delta image, the number of pages to be modified, the page numbers of the pages to be modified, the number of pages to be added, and the page numbers of the pages to be added.

In an alternative embodiment, the firmware update provision apparatus 100 may select a copy-based update method as the update method when the amount of free space remaining in the storage unit of the firmware update target device 200 is sufficient to store a new firmware image, but may select an overwrite-based update method as the update method when the amount of free space remaining in the storage unit of the firmware update target device 200 is insufficient to store the new firmware image.

In an alternative embodiment, when the amount of free space remaining in the storage unit of the firmware update target device 200 is insufficient to store a delta image, the firmware update provision apparatus 100 may create partial delta images by dividing the delta image into multiple partial delta images, each of which has a size corresponding to the amount of free space, and may sequentially transmit the partial delta images to the firmware update target device 200.

The firmware update target device 200 includes a smart device or an IoT device having a communication function.

Accordingly, because update is performed on a per-page basis using a page-based delta image, even if an update is interrupted, the update may be resumed from the page that was processed at the time of the interruption, whereby stability and efficiency may be improved.

Also, an update method is selected depending on the amount of free space remaining in the storage unit of an update target device, whereby update may be supported even for a low-specification device.

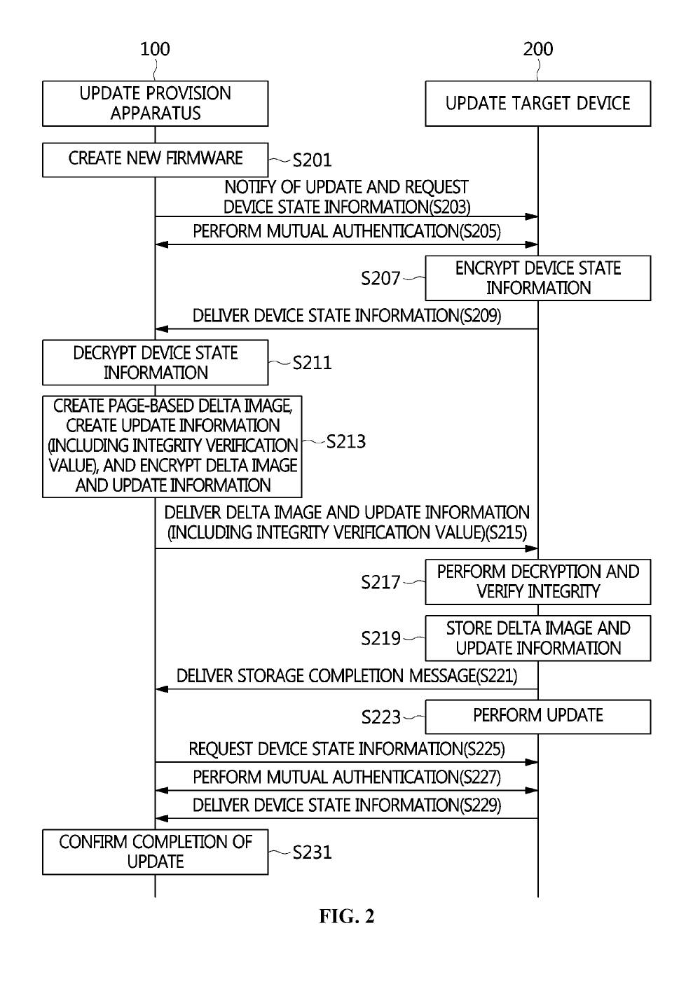

FIG. 2 is a view that shows an example of the operation process of the firmware update system 1 illustrated in FIG. 1.

Specifically, FIG. 2 shows the process of updating the firmware of an update target device 200 by a firmware update provision apparatus 100 in the firmware update system 1 according to an embodiment of the present invention.

Referring to FIG. 2, in the firmware update system 1 according to an embodiment of the present invention, the firmware update provision apparatus 100 creates new firmware in response to the release of a new version of firmware at step S201.

Also, in the firmware update system 1 according to an embodiment of the present invention, the firmware update provision apparatus 100 sends notification of update depending on the creation of new firmware to the firmware update target device 200 and requests device state information from the firmware update target device 200 at step S203.

Also, in the firmware update system 1 according to an embodiment of the present invention, the firmware update provision apparatus 100 and the firmware update target device 200 perform mutual authentication therebetween at step S205.

Here, depending on the performance or resources of the firmware update target device 200, various methods may be used for mutual authentication. For example, a certificate method using an asymmetric key encryption algorithm, such as Elliptic-Curve Cryptography (ECC), may be used, or a pre-shared key method using a symmetric key encryption algorithm, such as Advanced Encryption Standard (AES), may be used. As described above, when mutual authentication between the firmware update provision apparatus 100 and the firmware update target device 200 is completed, all messages sent and received therebetween are encrypted using a secret key created as the result of mutual authentication, whereby a secure communication channel is established.

Also, in the firmware update system 1 according to an embodiment of the present invention, the firmware update target device 200 encrypts device state information for firmware update at step S207 and transmits the encrypted device state information to the firmware update provision apparatus 100 at step S209.

Here, the device state information may include information about the version of the existing firmware of the firmware update target device 200 and information about the storage unit thereof. Also, the information about the storage unit may include information about the amount of free space available for a new firmware image in the storage unit.

Also, in the firmware update system 1 according to an embodiment of the present invention, the firmware update provision apparatus 100 decrypts the received device state information at step S211.

Also, in the firmware update system 1 according to an embodiment of the present invention, the firmware update provision apparatus 100 creates a page-based delta image based on a page size of flash memory in the storage unit, which is acquired from the information about the storage unit, and on the difference between the existing firmware and the new firmware, and then creates an integrity verification value. Then, the firmware update provision apparatus 100 creates firmware update information, including the integrity verification value and an update method, and encrypts the firmware update information at step S213.

Here, the integrity verification value may be a digital signature or a message authentication value used to verify the integrity of the created delta image and update information.

Here, the update method may be selected from among an overwrite-based update method, in which an existing firmware image is overwritten with a new firmware image, or a copy-based update method, in which the existing firmware image is not overwritten with the new firmware image.

Here, the copy-based update method may be a method in which a new firmware image is written from the last page thereof to a new area of the storage unit of the firmware update target device 200, and the overwrite-based update method may be a method in which the new firmware image is written from the last page thereof to the area in which the existing firmware image is stored in the storage unit of the firmware update target device 200 after the pages to be overwritten with the new firmware image due to update, among pages included in the existing firmware image, are backed up in the new area of the storage unit of the firmware update target device 200.

Here, the copy-based update method may be used when the amount of free space remaining in the storage unit of the firmware update target device 200 is sufficient to store the new firmware image, and the overwrite-based update method may be used when the amount of free space remaining in the storage unit of the firmware update target device 200 is insufficient to store the new firmware image.

Here, the update information includes information for identifying the firmware update target device 200, the new firmware version information, and the update method. Also, the update information may further include delta information including one or more of the total number of pages included in the delta image, the number of pages to be modified, the page numbers of the pages to be modified, the location of data to be modified, the length of data to be modified, the number of pages to be added, the page numbers of the pages to be added, the length of data on the last page to be added, and the integrity verification value.

Here, when the amount of free space remaining in the storage unit of the firmware update target device 200 is insufficient to store the delta image, the firmware update provision apparatus 100 may divide the delta image into partial delta images, each of which has a size corresponding to the amount of the free space, thereby creating the partial delta images.

Also, in the firmware update system 1 according to an embodiment of the present invention, the firmware update provision apparatus 100 delivers the encrypted update information and delta image to the firmware update target device 200 through a secure communication channel at step S215.

Here, when partial delta images are created, encrypted partial delta images may be delivered instead of the encrypted delta image.

Also, in the firmware update system 1 according to an embodiment of the present invention, the firmware update target device 200 decrypts the encrypted delta image and update information, verifies the integrity of the delta image and update information using the integrity verification value at step S217, and stores the delta image and the update information at step S219.

Here, a digital signature value or a message authentication value for verifying the integrity of the delta image and update information may be applied differently depending on the performance of the firmware update target device 200. That is, if the firmware update target device 200 supports the function of verifying a digital signature, a digital signature value is delivered, but if not, a message authentication value acquired using a hash function or block encryption may be delivered.

Also, in the firmware update system 1 according to an embodiment of the present invention, the firmware update target device 200 may deliver a message for announcing that the delta image and the update information have been stored to the firmware update provision apparatus 100 at step S221.

Here, when delivering the device state information at step S209, delivering the update information and the delta image at step S215, and delivering the storage completion message at step S221 are performed, an encrypted secure communication channel may be used.

Also, in the firmware update system 1 according to an embodiment of the present invention, the firmware update target device 200 updates the existing firmware with the new firmware at step S223 using the delta image based on the update method included in the update information.

Here, update status information is stored during update. Accordingly, when update is interrupted, update may be later resumed from the page that was processed at the time of interruption, or the state may be restored to the state before the update.

Here, the update status information may be set to a value (0x01) corresponding to ‘update in progress’, and then the firmware update target device 200 may be rebooted. When the firmware update target device 200 starts to reboot, a boot loader checks the update status information during the booting process and proceeds to complete update if the update status information is ‘update in progress’. That is, the firmware update may be completed using the method of creating and storing the new firmware image based on the update status information, the update information, the delta image, and the existing firmware image. When the firmware has been updated with the new firmware image, the update status information may be set to a value (0x00) corresponding to ‘update complete’, and the new firmware may be run.

Also, in the firmware update system 1 according to an embodiment of the present invention, the firmware update provision apparatus 100 requests device state information from the firmware update target device 200 at step S225.

Also, in the firmware update system 1 according to an embodiment of the present invention, the firmware update provision apparatus 100 and the firmware update target device 200 perform mutual authentication therebetween at step S227.

Also, in the firmware update system 1 according to an embodiment of the present invention, the firmware update target device 200 encrypts the device state information and transmits the encrypted device state information to the firmware update provision apparatus 100 at step S229.

Here, when the device state information is transmitted at step S229, an encrypted secure communication channel may be used.

Also, in the firmware update system 1 according to an embodiment of the present invention, the firmware update provision apparatus 100 decrypts the encrypted device state information, confirms the completion of update, and terminates the update process at step S231.

Accordingly, firmware update using a page-based delta image is provided, whereby the efficiency of the process of creating a delta image for update and the efficiency of a firmware update process may be improved, and the amount of data to be transmitted may be reduced.

Also, firmware update suitable for the state of the hardware resources of a firmware update target device is provided, whereby firmware update may be performed not only in a smart device that is capable of storing a new version of a firmware image but also in a low-specification smart device.

Also, firmware update in which, when firmware update is interrupted, an update may be resumed from the point at which the update was interrupted, or in which the firmware may be restored to the state before the update, is provided. Accordingly, even if an update error occurs because a network connection is blocked or because a smart device is turned off, it is possible to effectively respond thereto, whereby stability may be improved.

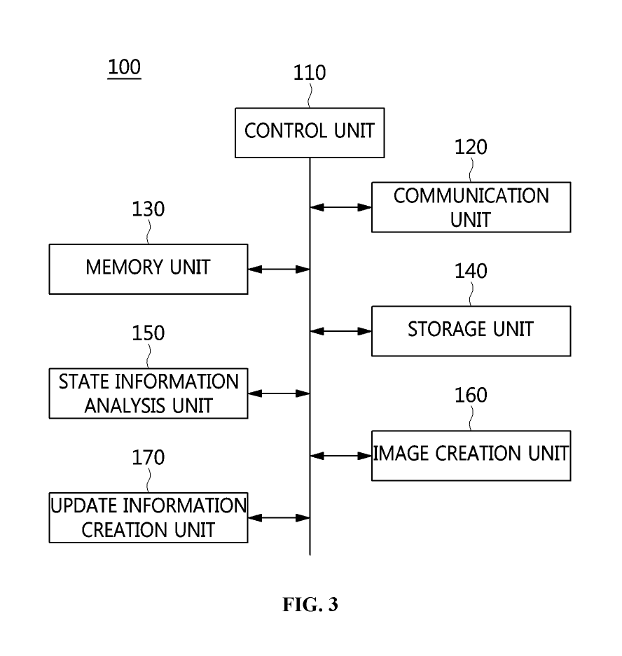

FIG. 3 is a block diagram that shows an apparatus 100 for providing firmware update according to an embodiment of the present invention.

Referring to FIG. 3, the firmware update provision apparatus 100 according to an embodiment of the present invention includes a control unit 110, a communication unit 120, a memory unit 130, a storage unit 140, a state information analysis unit 150, an image creation unit 160, an update information creation unit 170, and the like.

Specifically, the control unit 110 is a kind of central processing unit, and controls the overall process in the firmware update provision apparatus. That is, the control unit 110 may provide various functions by controlling the communication unit 120, the state information analysis unit 150, the image creation unit 160, the update information creation unit 170, and the like.

Here, the control unit 110 may include all kinds of devices capable of processing data, such as a processor and the like. Here, the term ‘processor’ may indicate, for example, a data-processing device embedded in hardware, which has a circuit physically structured for performing functions represented as code or instructions included in a program. An example of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The communication unit 120 provides a communication interface that is necessary in order to send or receive signals between the firmware update provision apparatus 100 and a firmware update target device (200 in FIG. 1).

Here, the communication unit 120 may be a device including hardware and software that are necessary in order to send and receive signals, such as control signals or data signals, through a wired or wireless connection with another network device.

Here, a communication function includes wired and wireless communication methods, and the wireless communication methods may include Wi-Fi, ZigBee, BLE, and the like.

Here, the communication unit 120 may receive device state information from the firmware update target device (200 in FIG. 1), and may transmit a delta image and update information for firmware update to the firmware update target device (200 in FIG. 1).

In an alternative embodiment, when the amount of free space remaining in the storage unit of the firmware update target device (200 in FIG. 1) is insufficient to store the delta image, the communication unit 120 may sequentially send partial delta images, each of which is created so as to have a size corresponding to the amount of the free space, to the firmware update target device (200 in FIG. 1).

The memory unit 130 functions to temporarily or permanently store data processed by the control unit 110. Here, the memory unit 130 may include RAM, ROM, and flash ROM, but the present invention is not limited thereto.

The storage unit 140 stores various versions of firmware images and information about firmware update policies used in the firmware update target device (200 in FIG. 1).

The state information analysis unit 150 checks a page size of flash memory included in the storage unit of the firmware update target device (200 in FIG. 1), the amount of free space reserved for firmware installation in the storage unit of the firmware update target device (200 in FIG. 1), information about the version of existing firmware, and the like by analyzing the device state information received from the firmware update target device 200.

The image creation unit 160 creates a page-based delta image based on the difference between the existing firmware and new firmware using the information analyzed by the state information analysis unit 150.

In an alternative embodiment, when the amount of free space remaining in the storage unit of the firmware update target device (200 in FIG. 1) is insufficient to store the delta image, the image creation unit 160 may create partial delta images by dividing the delta image into partial delta images, each of which has a size corresponding to the amount of free space.

The update information creation unit 170 creates update information in which an update method to be used to update the existing firmware with new firmware in the firmware update target device (200 in FIG. 1) is specified.

In an alternative embodiment, the update information creation unit 170 may select an update method from among an overwrite-based update method, in which an existing firmware image is overwritten with a new firmware image, and a copy-based update method, in which the existing firmware image is not overwritten with the new firmware image.

In an alternative embodiment, the copy-based update method may be a method in which a new firmware image is written from the last page thereof to a new area of the storage unit of the firmware update target device (200 in FIG. 1), and the overwrite-based update method may be a method in which the new firmware image is written from the last page thereof to the area in which the existing firmware image is stored in the storage unit of the firmware update target device after the pages to be overwritten with the new firmware image due to update, among pages included in the existing firmware image, are backed up in the new area of the storage unit of the firmware update target device (200 in FIG. 1).

In an alternative embodiment, the copy-based update method and the overwrite-based update method may be configured to store update status information during the update process in order to resume update from the page that was processed at the time of interruption or to revert to the previous state before the update in the event of interruption of the update.

In an alternative embodiment, the update information creation unit 170 may select the copy-based update method when the amount of free space remaining in the storage unit of the firmware update target device (200 in FIG. 1) is sufficient to store a new firmware image, but may select the overwrite-based update method when the amount of free space remaining in the storage unit of the firmware update target device (200 in FIG. 1) is insufficient to store the new firmware image.

In an alternative embodiment, the update information includes information for identifying the firmware update target device (200 in FIG. 1), new firmware version information, and the update method. Also, the update information may further include delta information including one or more of the total number of pages included in a delta image, the number of pages to be modified, the page numbers of the pages to be modified, the location of data to be modified, the length of the data to be modified, the number of pages to be added, the page numbers of the pages to be added, the length of data on the last page to be added, and an integrity verification value.

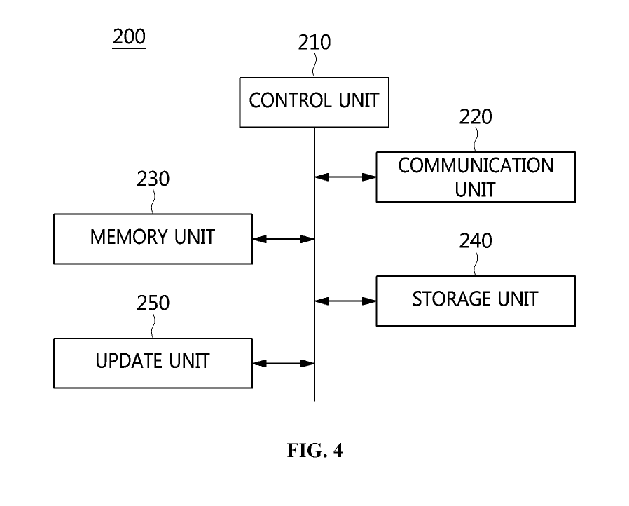

FIG. 4 is a block diagram that shows a firmware update target device 200 according to an embodiment of the present invention.

Referring to FIG. 4, the firmware update target device 200 according to an embodiment of the present invention includes a control unit 210, a communication unit 220, a memory unit 230, a storage unit 240, an update unit 250, and the like.

Specifically, the control unit 210 is a kind of central processing unit, and controls the overall process in the firmware update target device. That is, the control unit 210 may provide various functions by controlling the communication unit 220, the storage unit 240, the update unit 250, and the like.

Here, the control unit 210 may include all kinds of devices capable of processing data, such as a processor and the like. Here, the term ‘processor’ may indicate, for example, a data-processing device embedded in hardware, which has a circuit physically structured for performing functions represented as code or instructions included in a program. An example of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The communication unit 220 provides a communication interface that is necessary in order to send or receive signals between the firmware update target device 200 and a firmware update provision apparatus (100 in FIG. 1).

Here, the communication unit 220 may be a device including hardware and software that are necessary in order to send and receive signals, such as control signals or data signals, through a wired or wireless connection with another network device.

Here, the communication function includes wired and wireless communication methods, and the wireless communication methods may include Wi-Fi, ZigBee, BLE, and the like.

Here, the communication unit 220 may transmit device state information to the firmware update provision apparatus (100 in FIG. 1), and may receive a delta image and update information for firmware update from the firmware update provision apparatus (100 in FIG. 1).

Here, the device state information may include information about the existing firmware, information about the storage unit, and the like. Also, the information about the storage unit may include information about the amount of space that can be allocated for a new firmware image.

Here, the communication unit 220 may receive a page-based delta image, which is created based on a page size of flash memory included in the storage unit 240 and on the difference between the existing firmware and new firmware, and update information, including an update method, from the firmware update provision apparatus (100 in FIG. 1).

In an alternative embodiment, the communication unit 220 may sequentially receive, from the firmware update provision apparatus (100 in FIG. 1), partial delta images, each of which is created so as to have a size corresponding to the amount of free space in the storage unit 240, because the amount of free space remaining in the storage unit 240 is insufficient to store a delta image.

In an alternative embodiment, the update method may be selected from among an overwrite-based update method, in which the existing firmware image is overwritten with a new firmware image, and a copy-based update method, in which the existing firmware image is not overwritten with the new firmware image.

In an alternative embodiment, the copy-based update method may be selected when the amount of free space in the storage unit 240 is sufficient to store the new firmware image, and the overwrite-based update method may be selected when the amount of free space in the storage unit 240 is insufficient to store the new firmware image.

In an alternative embodiment, the update information includes information for identifying the firmware update target device 200, the new firmware version information, and the update method. Also, the update information may further include delta information including one or more of the total number of pages included in a delta image, the number of pages to be modified, the page numbers of the pages to be modified, the location of data to be modified, the length of the data to be modified, the number of pages to be added, the page numbers of the pages to be added, the length of data on the last page to be added, and an integrity verification value.

The memory unit 230 functions to temporarily or permanently store data processed by the control unit 210. Here, the memory unit 230 may include RAM, ROM, and flash ROM, but the present invention is not limited thereto.

The storage unit 240 stores a firmware image used in the firmware update target device 200, firmware update information, and the like.

Here, in the storage unit 240, the area in which firmware is stored and run may be flash memory.

The update unit 250 updates the existing firmware with new firmware on a per-page basis using the delta image and the update information, received from the firmware update provision apparatus (100 in FIG. 1), based on the update method.

In an alternative embodiment, when the update method included in the update information is a copy-based update method, the update unit 250 writes a new firmware image from the last page thereof to a new area of the storage unit 240. When the update method is an overwrite-based update method, the update unit 250 may write the new firmware image from the last page thereof to the area in which the existing firmware image is stored in the storage 240 after backing up the pages to be overwritten with the new firmware image due to update, among pages included in the existing firmware image, in the new area of the storage unit 240.

In an alternative embodiment, the update unit 250 stores update status information while updating firmware, whereby, when update is interrupted, the function of resuming update from the page that was processed at the time of interruption or restoring the firmware to the previous state before the update may be provided using the update status information.

In an alternative embodiment, when it receives partitioned delta images, the update unit 250 may perform full update by repeatedly performing partial update using the partitioned delta images.

Accordingly, firmware update using a page-based delta image is provided, whereby the efficiency of a firmware update process may be improved, and the amount of data to be transmitted may be reduced.

Also, firmware update suitable for the state of the hardware resources of a firmware update target device is provided, whereby firmware update may be performed not only in a smart device that is capable of storing a new version of a firmware image but also in a low-specification smart device.

Also, firmware update in which, when firmware update is interrupted, update may be resumed from the point at which the update is interrupted, or the firmware may be restored to the state before the update was provided. Accordingly, even if an update error occurs because a network connection is blocked or because a smart device is turned off, it is possible to effectively respond thereto, whereby stability may be improved.

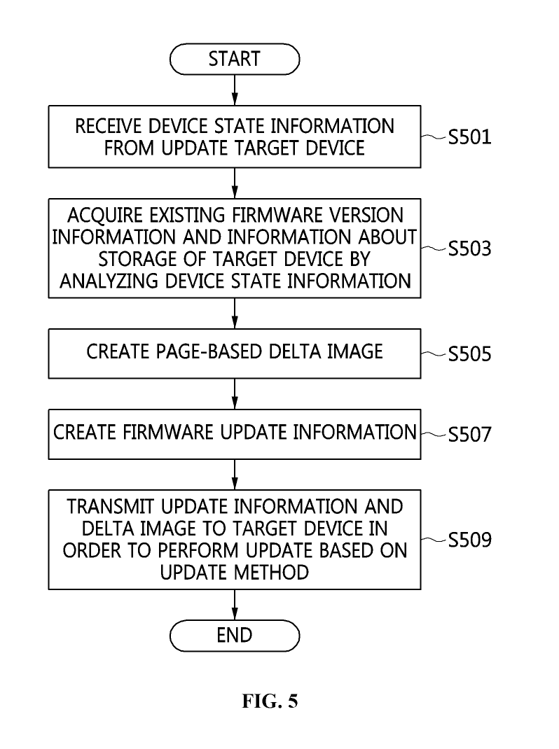

FIG. 5 is a flowchart that shows a firmware update method according to an embodiment of the present invention.

This embodiment explains a firmware update method from the aspect of a firmware update provision apparatus (100 in FIG. 1).

Referring to FIG. 5, in the firmware update method according to an embodiment of the present invention, the firmware update provision apparatus (100 in FIG. 1) receives device state information from a firmware update target device (200 in FIG. 1) at step S501.

Also, in the firmware update method according to an embodiment of the present invention, the firmware update provision apparatus (100 in FIG. 1) acquires information about the existing firmware and the storage unit of the firmware update target device (200 in FIG. 1) by analyzing the device state information at step S503.

Here, the information about the storage unit may include a page size of flash memory included in the storage unit of the firmware update target device (200 in FIG. 1), the amount of free space that is reserved for firmware installation in the storage unit of the firmware update target device (200 in FIG. 1), and the like.

Also, in the firmware update method according to an embodiment of the present invention, using the information about the storage unit, the firmware update provision apparatus (100 in FIG. 1) creates a page-based delta image based on a page size of flash memory included in the storage unit of the firmware update target device (200 in FIG. 1) and on the difference between the existing firmware and new firmware at step S505.

Also, in the firmware update method according to an embodiment of the present invention, the firmware update provision apparatus (100 in FIG. 1) creates update information in which an update method is specified at step S507.

Here, a copy-based update method may be configured such that a new firmware image is written from the last page thereof to a new area of the storage unit of the firmware update target device (200 in FIG. 1), and an overwrite-based update method may be configured such that the new firmware image is written from the last page thereof to the area in which the existing firmware image is stored in the storage unit of the firmware update target device (200 in FIG. 1), after the pages to be overwritten with the new firmware image due to update, among pages included in the existing firmware image, are backed up in the new area of the storage unit of the firmware update target device (200 in FIG. 1).

Here, the copy-based update method may be used when the amount of free space remaining in the storage unit of the firmware update target device (200 in FIG. 1) is sufficient to store a new firmware image, and the overwrite-based update may be used when the amount of free space remaining in the storage unit of the firmware update target device (200 in FIG. 1) is insufficient to store the new firmware image.

Here, the update information includes information for identifying the firmware update target device (200 in FIG. 1), new firmware version information, and the update method. Also, the update information may further include delta information including one or more of the total number of pages included in a delta image, the number of pages to be modified, the page numbers of the pages to be modified, the location of data to be modified, the length of the data to be modified, the number of pages to be added, the page numbers of the pages to be added, the length of data on the last page to be added, and an integrity verification value.

Also, in the firmware update method according to an embodiment of the present invention, the firmware update provision apparatus (100 in FIG. 1) transmits the update information and the delta image to the firmware update target device (200 in FIG. 1) at step S507 such that the firmware is updated based on the update method in the firmware update target device (200 in FIG. 1).

Here, update status information is stored during update. Accordingly, when update is interrupted, it is possible to resume update from the page that was processed at the time of interruption or to revert to the state before the update using the update status information.

Accordingly, firmware update using a page-based delta image is provided, whereby the efficiency of the process of creating a delta image for update and the efficiency of the firmware update process may be improved, and the amount of data to be transmitted may be reduced.

Also, firmware update suitable for the state of the hardware resources of a firmware update target device is provided, whereby firmware update may be performed not only in a smart device that is capable of storing a new version of a firmware image but also in a low-specification smart device.

Also, firmware update in which, when firmware update is interrupted, update may be resumed from the point at which the update was interrupted, or the firmware may be restored to the state before the update, is provided. Accordingly, even if an update error occurs because a network connection is blocked or because a smart device is turned off, it is possible to effectively respond thereto, whereby stability may be improved.

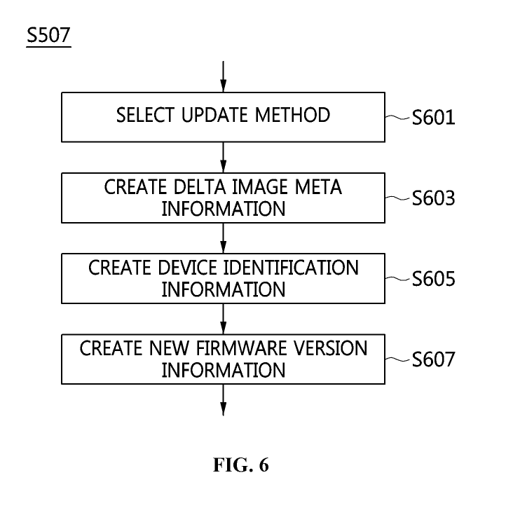

FIG. 6 is a flowchart that shows an example of the step (S507) of creating update information, illustrated in FIG. 5.

Referring to FIG. 6, in the step (S507) of creating update information, illustrated in FIG. 5, an update method, which specifies the method of updating firmware in the firmware update target device (200 in FIG. 1), is selected at step S601.

Here, the update method may be selected from among an overwrite-based update method, in which the existing firmware image is overwritten with a new firmware image, and a copy-based update method, in which the existing firmware image is not overwritten with the new firmware image.

Also, in the step (S507) of creating update information, illustrated in FIG. 5, meta information corresponding to a delta image for firmware update is created at step S603.

Here, the meta information may include the total number of pages included in the delta image, the number of pages to be modified, the page numbers of the pages to be modified, the number of pages to be added, and the page numbers of the pages to be added.

Also, in the step (S507) of creating update information, illustrated in FIG. 5, device identification information corresponding to the firmware update target device (200 in FIG. 1), the firmware of which is to be updated, is created at step S605.

Also, in the step (S507) of creating update information, illustrated in FIG. 5, new firmware version information is created at step S607.

In an alternative embodiment, among the above steps S601, S603, S605 and S607, selecting the update method at step S601 and creating the meta information at step S603 may be performed in parallel.

In an alternative embodiment, among the above steps S601, S603, S605 and S607, creating the meta information at step S603 may be performed before selecting the update method at step S601.

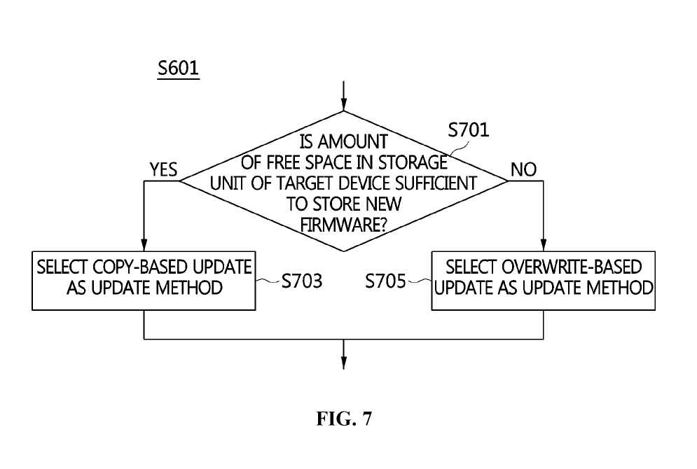

FIG. 7 is a flowchart that shows an example of the step (S601) of selecting an update method, illustrated in FIG. 6.

Referring to FIG. 7, in the step of (S601) of selecting an update method, illustrated in FIG. 6, whether the amount of free space remaining in the storage unit of the firmware update target device (200 in FIG. 1) is sufficient to store new firmware is determined at step S701.

When it is determined at step S701 that the amount of free space remaining in the storage unit of the firmware update target device (200 in FIG. 1) is sufficient to store new firmware, a copy-based update method is selected as the update method at step S703.

Here, the copy-based update method may be configured such that a new firmware image is written from the last page thereof to a new area of the storage unit of the firmware update target device (200 in FIG. 1).

When it is determined at step S701 that the amount of free space remaining in the storage unit of the firmware update target device (200 in FIG. 1) is insufficient to store new firmware, an overwrite-based method is selected as the update method at step S705.

Here, the overwrite-based update method may be configured such that a new firmware image is written from the last page thereof to the area in which the existing firmware image is stored in the storage unit of the firmware update target device (200 in FIG. 1) after the pages to be overwritten with the new firmware image due to update, among pages included in the existing firmware image, are backed up in a new area of the storage unit of the firmware update target device (200 in FIG. 1).

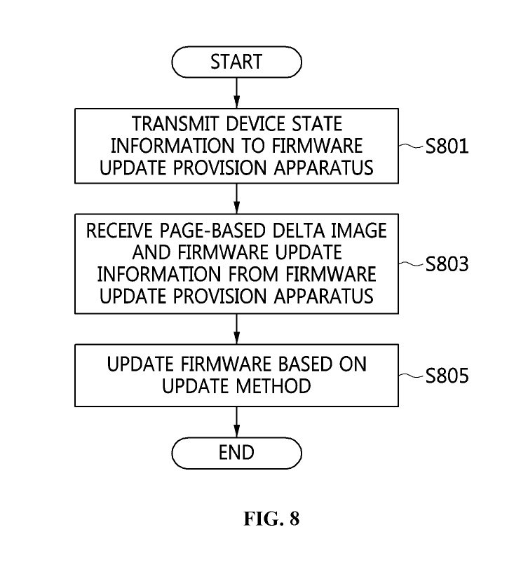

FIG. 8 is a flowchart that shows a firmware update method according to an embodiment of the present invention.

This embodiment explains a firmware update method from the aspect of a firmware update target device (200 in FIG. 1).

Referring to FIG. 8, in the firmware update method according to an embodiment of the present invention, the firmware update target device (200 in FIG. 1) transmits device state information to the firmware update provision apparatus (100 in FIG. 1) at step S801.

Here, the device state information may include information about the version of existing firmware and information about a storage unit.

Here, the information about the storage unit may include a page size of flash memory included in the storage unit of the firmware update target device (200 in FIG. 1), the amount of free space that is reserved for firmware installation in the storage unit of the firmware update target device (200 in FIG. 1), and the like.

Also, in the firmware update method according to an embodiment of the present invention, the firmware update target device (200 in FIG. 1) receives a page-based delta image, which is created based on a page size of flash memory included in the storage unit and on the difference between the existing firmware and new firmware, and update information, including an update method, from the firmware update provision apparatus (100 in FIG. 1) at step S803.

Here, the update method may be selected from among an overwrite-based update method, in which an existing firmware image is overwritten with a new firmware image, and a copy-based update method, in which the existing firmware image is not overwritten with the new firmware image.

Here, the copy-based update method may be selected when the amount of free space remaining in the storage unit of the firmware update target device (200 in FIG. 1) is sufficient to store the new firmware image, and the overwrite-based update method may be selected when the amount of free space remaining in the storage unit of the firmware update target device (200 in FIG. 1) is insufficient to store the new firmware image.

Here, the update information includes information for identifying the firmware update target device (200 in FIG. 1), new firmware version information, and the update method. Also, the update information may further include delta information including one or more of the total number of pages included in a delta image, the number of pages to be modified, the page numbers of the pages to be modified, the location of data to be modified, the length of the data to be modified, the number of pages to be added, the page numbers of the pages to be added, the length of data on the last page to be added, and an integrity verification value.

Also, in the firmware update method according to an embodiment of the present invention, using the delta image and the update information, the firmware update target device (200 in FIG. 1) updates the existing firmware in units of pages with new firmware based on the update method at step S805.

Here, update status information is stored while firmware is being updated, whereby a function of resuming update from the page that was processed at the time of interruption or reverting to the state before the update may be provided using the update status information in the event of interruption of the update.

Accordingly, firmware update using a page-based delta image is provided, whereby the efficiency of a firmware update process may be improved, and the amount of data to be transmitted may be reduced.

Also, firmware update in which, when firmware update is interrupted, update may be resumed from the point at which the update was interrupted, or the firmware may be restored to the state before the update, is provided. Accordingly, even if an update error occurs because a network connection is blocked or because a smart device is turned off, it is possible to effectively respond thereto, whereby stability may be improved.

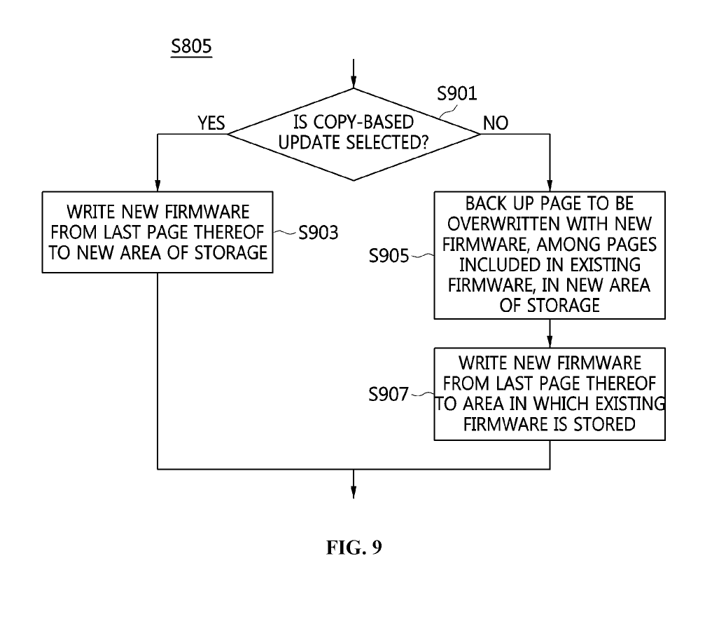

FIG. 9 is a flowchart that shows an example of the step (S805) of performing update, illustrated in FIG. 8.

Referring to FIG. 9, in the step (S805) of performing update illustrated in FIG. 8, whether an update method is a copy-based update method is determined at step S901.

When it is determined at step S901 that the update method is a copy-based update method, a new firmware image is written from the last page thereof to a new area of the storage unit of the firmware update target device (200 in FIG. 1) at step S903.

When it is determined at step S901 that the update method is an overwrite-based update method, the pages to be overwritten with a new firmware image due to update, among pages included in the existing firmware image, are backed up in a new area of the storage unit of the firmware update target device (200 in FIG. 1) at step S905, and the new firmware image is written from the last page thereof to the area in which the existing firmware image is stored in the storage unit of the firmware update target device (200 in FIG. 1) at step S907.

Accordingly, firmware update suitable for the state of the hardware resources of a firmware update target device is provided, whereby firmware update may be performed not only in a smart device that is capable of storing a new version of a firmware image but also in a low-specification smart device.

In an alternative embodiment, among the above steps S901, S903, S905 and S907, backing up pages at step S905 and writing a new firmware image at step S907 may be performed in parallel.

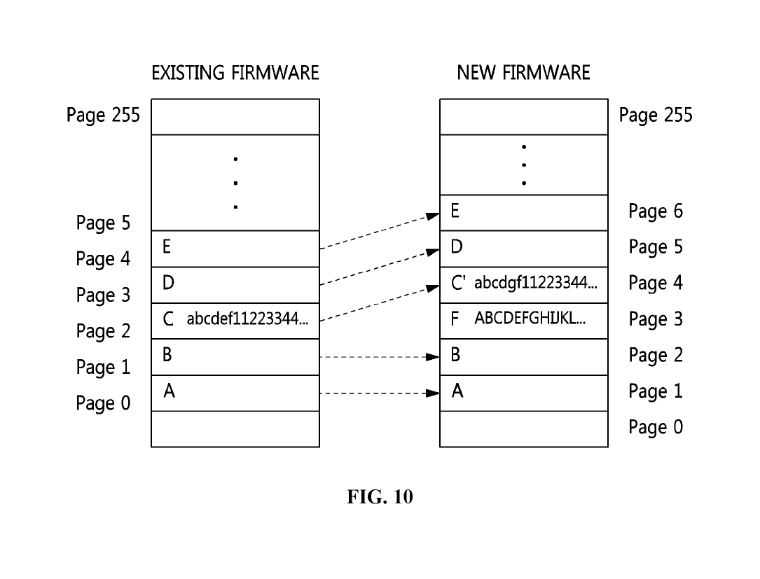

FIG. 10 is a view that shows an example of firmware images of flash memory, which are configured with pages.

Referring to FIG. 10, the existing firmware image, formed on a per-page basis, has five pages (corresponding to data A, B, C, D and E), and a new firmware image, formed on a per-page basis, has six pages (corresponding to data A, B, F, C′, D and E).

Here, a delta image for update is created using information about modified pages and added pages, which is acquired by comparing each of the pages of the existing firmware image with that of the new firmware image. Also, meta information about the created delta image is created.

When the existing firmware image is compared with the new firmware image, the new firmware image is configured such that one byte in data C is modified and one page of data F is added to the existing firmware image. Therefore, the size of a delta image to be created may be 2 pages.

However, this embodiment is for the convenience of description, and if the entire page is not modified and the number of modified bytes is small, the location of the modified data and the length thereof are included in the firmware update information, whereby it is possible to reduce the size of the firmware delta image to be created. Also, when it is determined as a result of the comparison with the existing firmware image that the length of data to be added is less than the size of a single page, information about the length of data added to the last page is included in the firmware update information, whereby the size of the firmware delta image to be created may be reduced.

Particularly, when a delta image is created, if it is determined that the amount of free space is insufficient to store the entire delta image, partial delta images, each of which has a size less than the amount of free space, may be created with reference to information about the storage unit of the update target device.

Also, the update information may include information for identifying the device in which update is to be performed, new firmware version information, delta image meta information, and the like.

Here, the meta information may include the total number of pages, the number of pages to be modified and the page numbers thereof, the number of pages to be added and the page numbers thereof, and the like.

For example, when the overwrite-based update method is used, meta information may include revisions, such as moving data C from page 3 to page 4, changing data C to C′, moving data D from page 4 to page 5, moving data E from page 5 to page 6, and adding data F to page 3.

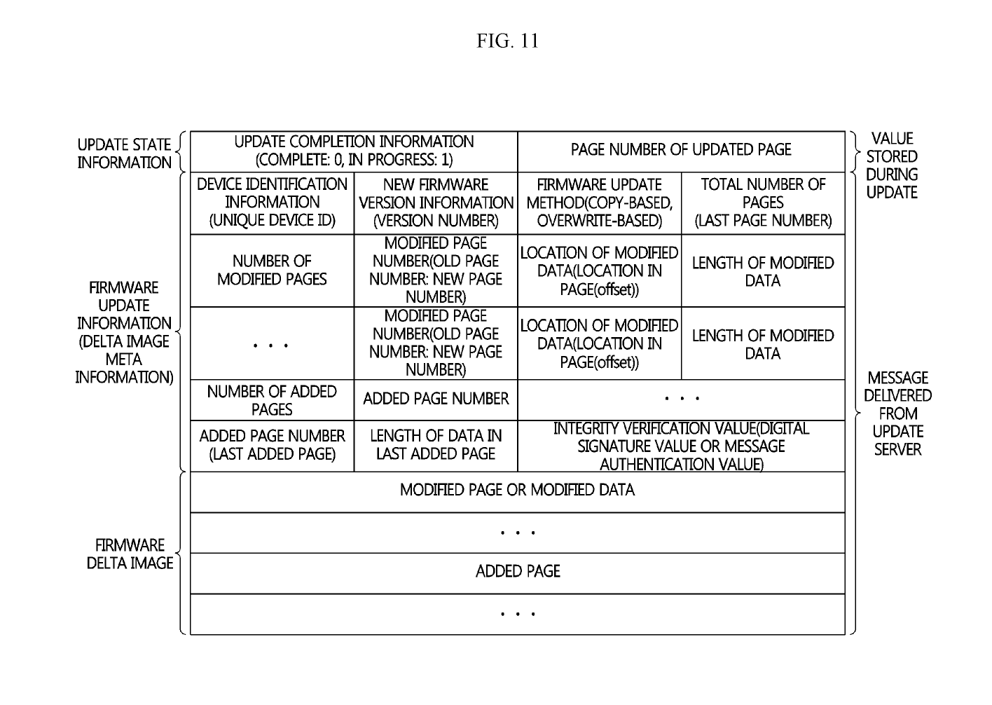

FIG. 11 is a view that shows an example of the structures of update status information, update information, and a delta image.

Referring to FIG. 11, update status information is a value stored while update is being performed in the firmware update target device (200 in FIG. 1), and firmware update information and the firmware delta image are values transmitted from the firmware update provision apparatus (100 in FIG. 1) and stored in the firmware delta image area of the firmware update target device (200 in FIG. 1).

Here, the firmware update information and the firmware delta image, which are delivered as messages from the firmware update provision apparatus (100 in FIG. 1), may be transmitted as data messages using a standard message format, which is used in the existing communication protocol, but the present invention does not include specifications for a message structure used in the standard protocol.

Also, the value of ‘update completion information’ in the update status information is set to ‘in progress (0x01)’ when the firmware update information and the firmware delta image have been stored in the firmware update target device (200 in FIG. 1), and is set to ‘complete (0x00)’ when update is performed and completed.

Also, while update is being performed in units of pages of flash memory, the page number of flash memory for which the update is completed is stored in ‘page number of updated page’. Accordingly, when update is interrupted due to the interruption of the supply of power or some other error, this information may be used to continue the update from the corresponding page and complete the update later.

Also, the firmware update information includes information for identifying the firmware update target device (200 in FIG. 1), new firmware version information, and the update method, and also includes delta information as meta information about the firmware delta image. Here, the delta information includes one or more of the total number of pages of firmware, the number of pages to be modified, the page numbers of the pages to be modified, the location of data to be modified, the length of the data to be modified, the number of pages to be added, the page numbers of the pages to be added, the length of data in the last page to be added, and an integrity verification value. Here, the firmware update information is also formed on a per-page basis. When the number of delta images is small, the firmware update information may be included in a single page, or the amount thereof may be more than one page.

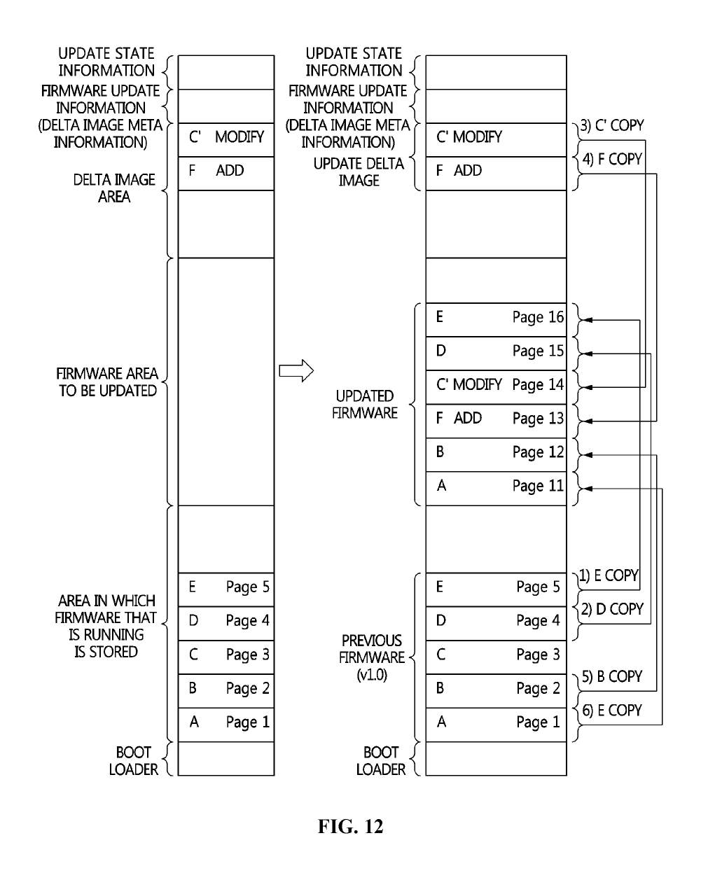

FIG. 12 is a view that shows an update process using a copy-based update method for the example illustrated in FIG. 9.

Referring to FIG. 12, the storage unit of a firmware update target device (200 in FIG. 1) has free space, the amount of which is sufficient to store new firmware.

Here, a firmware update provision apparatus (100 in FIG. 1) transmits firmware update information and a delta image to the firmware update target device (200 in FIG. 1) through a secure communication channel, and the firmware update target device (200 in FIG. 1) stores the received firmware update information and delta image in a delta image storage area in flash memory.

Then, the firmware update target device (200 in FIG. 1) sets the value of update completion information in update status information to ‘in progress (0x01)’, sends a ‘delta image storage completion’ message to the firmware update provision apparatus (100 in FIG. 1), and reboots itself in order to perform the firmware update. When rebooting is completed, the boot loader checks the update status information during the device booting process. If the value of the update completion information in the update status information is ‘in progress (0x01)’, the boot loader may perform a process for completing update.

In the firmware update process, a new firmware image is stored in the firmware area reserved for update using the stored firmware update information, the stored delta image, and the existing firmware according to the sequence illustrated in FIG. 12. When update is completed, the value of the update completion information in the update status information may be set to ‘complete (0x00)’.

That is, after ‘1) copy E’ is performed, page number 16 is stored in the update status information, and after ‘2) copy D’ is performed, page number 15 is stored in the update status information. After ‘3) copy C′’ is performed, page number 14 is stored in the update status information, and after ‘4) copy F’ is performed, page number 13 is stored in the update status information. After ‘5) copy B’ is performed, page number 12 is stored in the update status information, and after ‘6) copy E’ is performed, page number 11 is stored in the update status information. When the new firmware image has been stored using the above-described method, the value of the update completion information in the update status information is set to ‘complete (0x00)’, and the address of the new firmware image is set as a start address, whereby firmware update is completed.

Here, when ‘3) copy C″ is performed, if data C’ are not delivered as single-page-size data, data C′, which correspond to data of the new version of the delta image, may be created from data C, which are included in page 3 of the code of the previous version, with reference to the firmware update information (meta information about the delta image). That is, rather than transmitting data C′ as single-page-size data, only data changed from C to C′ are delivered, and update may be performed using the delivered data.

Meanwhile, when update is not completed due to the occurrence of an error during update, if the value of the update completion information in the update status information is ‘in progress (0x01)’, the boot loader checks the page numbers of the updated pages and resumes firmware update from the point at which the update was interrupted, thereby completing update. To this end, a new firmware image is created and stored from the last page thereof, and the page numbers may be stored in the update status information.

Particularly, when a request to revert to the previous version of firmware is made, if the update method specified in the update information is determined to be a copy-based update method, the boot loader of the firmware update target device (200 in FIG. 1) merely changes the start address to the address of the previous firmware image without the need to receive the previous version of a firmware image or additional information thereabout, whereby restoration of the previous firmware version may be performed.

Accordingly, even when an error occurs during the update process, the firmware update target device (200 in FIG. 1) may continue update using the update status information after rebooting, thereby completing update. Also, because the existing firmware image remains in a separate area without change, restoration of the previous version of firmware may be easily performed.

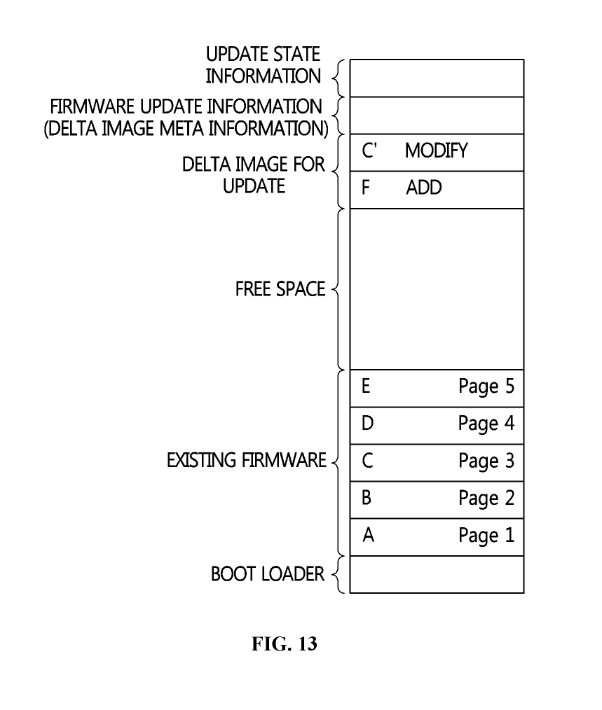

FIGS. 13 to 18 are views that show an update process using an overwrite-based update method for the example illustrated in FIG. 9.

Referring to FIGS. 13 to 18, the storage unit of a firmware update target device (200 in FIG. 1) is not capable of securing the amount of free space for storing new firmware.

Here, a firmware update provision apparatus (100 in FIG. 1) transmits firmware update information and a delta image to the firmware update target device (200 in FIG. 1) through a secure communication channel, and the firmware update target device (200 in FIG. 1) stores the received firmware update information and delta image in the delta image storage area of flash memory.

Then, the firmware update target device (200 in FIG. 1) sets the value of the update completion information in the update status information to ‘in progress (0x01)’, sends a ‘delta image storage completion’ message to the firmware update provision apparatus (100 in FIG. 1), and reboots itself in order to perform the firmware update. When rebooting is completed, the boot loader checks the update status information during the device booting process. If the value of the update completion information in the update status information is ‘in progress (0x01)’, the boot loader may perform a process for completing update.

In FIGS. 13 to 18, an overwrite-based update method is used, that is, firmware is updated by creating and storing a new firmware image in the area in which the existing firmware image is stored.

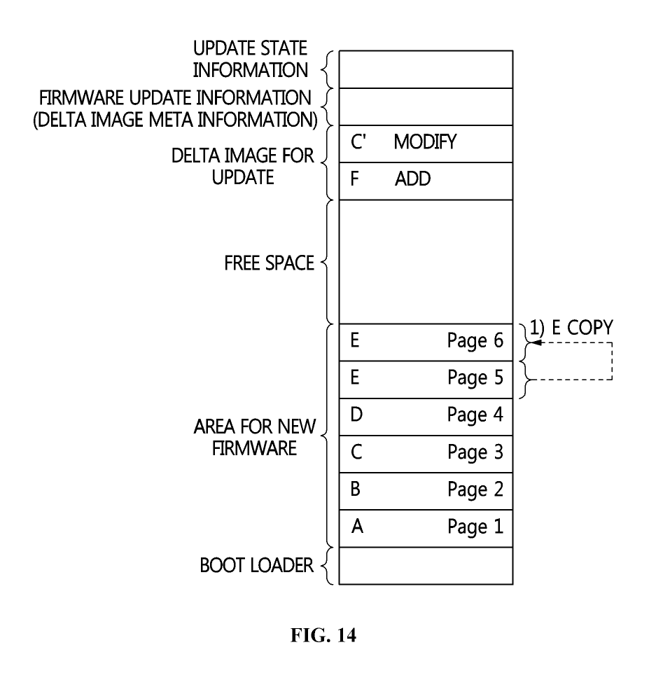

Referring to 13, after a boot loader detects that the value of the update completion information in the update status information is ‘update in progress’ during a booting process, the boot loader checks the total size of firmware, the size and location of updated data, and the size and location of added data using the firmware update information, thereby checking the size and location of data that are not changed from the existing firmware image. That is, it may be confirmed that one page is modified, one page is added, and the total size of the firmware is increased by one page. Then, the processes illustrated in FIGS. 14 to 18 are sequentially performed, whereby firmware update is completed.

Here, a new firmware image may be created and stored from the last page thereof in order to easily resume the update process or easily revert to the previous firmware version when an error occurs during the update process due to the interruption of the supply of power or the like. Also, whenever the update process for each page is completed, the page number thereof may be stored in the update status information.

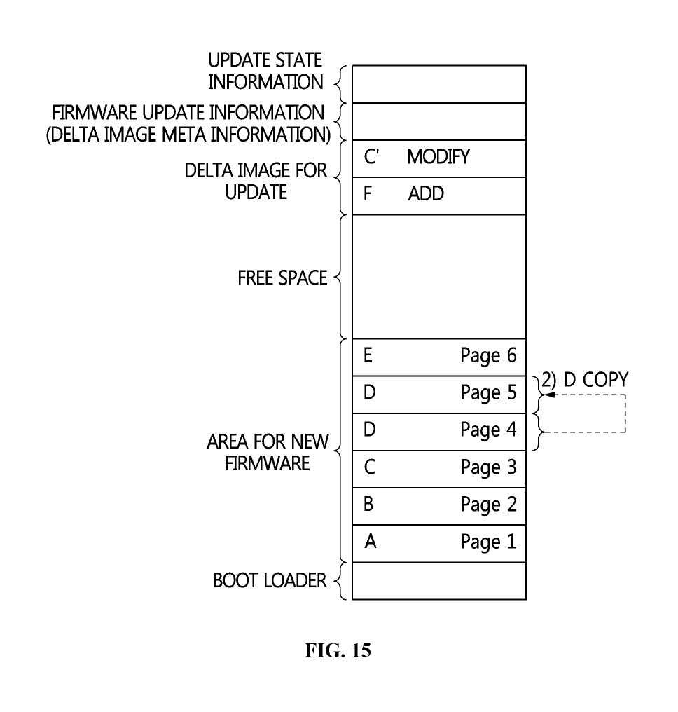

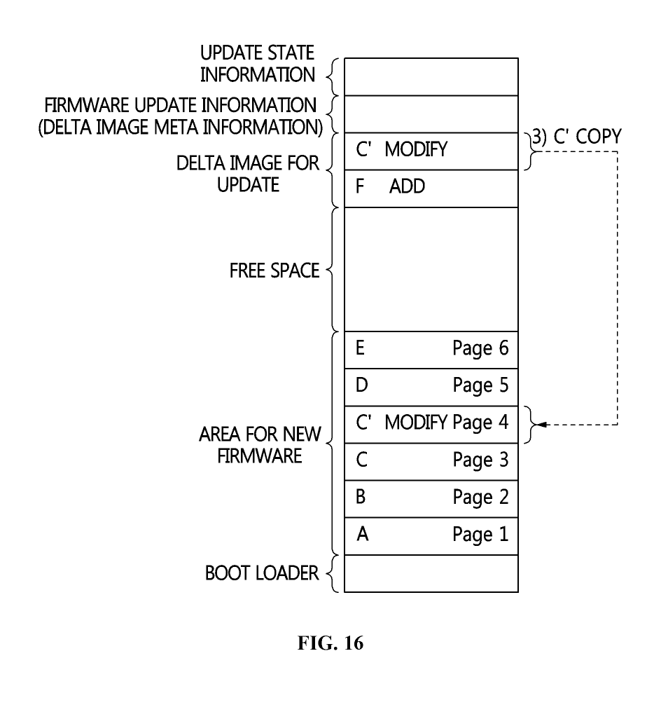

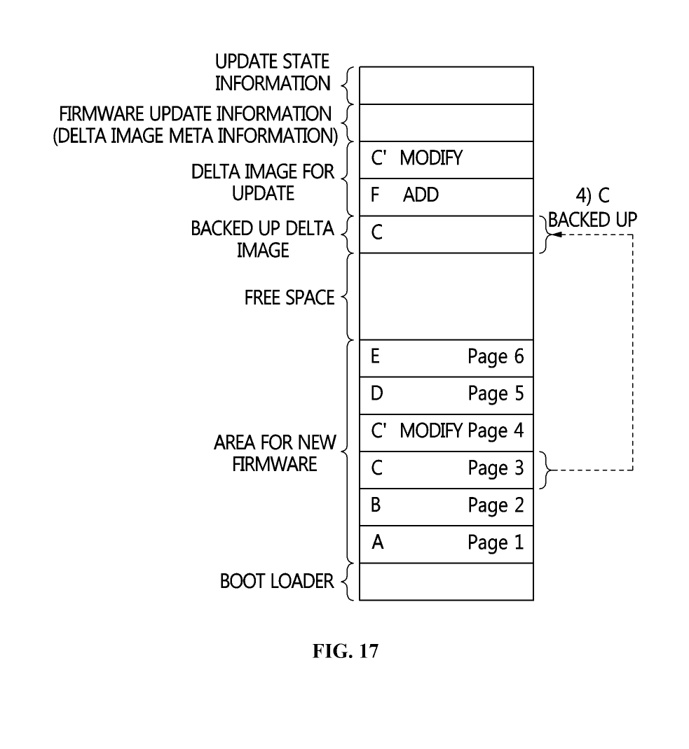

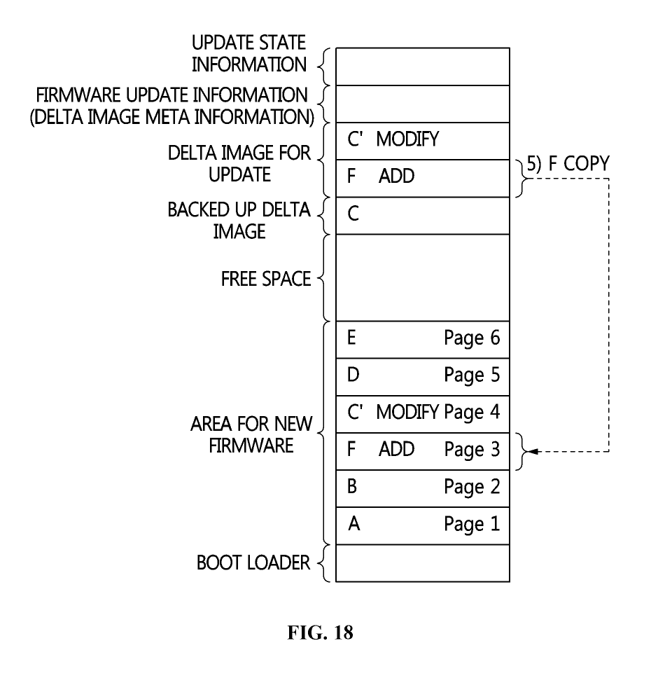

Referring to FIG. 14, after ‘1) copy E’ is performed, page number 6 is stored in the update status information. Referring to FIG. 15, after ‘2) copy D’ is performed, page number 5 is stored in the update status information. Referring to FIG. 16, after ‘3) copy C′’ is performed, page number 4 is stored in the update status information. Referring to FIG. 17, ‘4) back up C’ is performed. Referring to FIG. 18, after ‘5) copy F’ is performed, page number 3 is stored in the update status information. When the new firmware image has been stored using the above-described method, the value of the update completion information in the update state information is set to ‘complete (0x00)’, and the address of the new firmware image is set as the start address, whereby firmware update is completed.

Here, because page 1 and page 2 are not modified, they can remain unchanged.

However, when the update process is not completed because an error occurs during the update process, the boot loader checks the update status information. If the checked value of the update completion information in the update status information is ‘in progress (0x01)’, the firmware update process is resumed from the point at which the update was interrupted by checking the page numbers of pages that have already been stored, thereby completing the update process. To this end, the new firmware image is created and stored from the last page thereof, and the page numbers of pages that have been stored may be stored in the update status information.

Particularly, when a request to revert to the previous version of firmware is made, if the update method specified in the update information is determined to be the overwrite-based update method, the previous version of firmware may be restored by performing the processes illustrated in FIGS. 14 to 18 in reverse order without the need to receive the previous version of a firmware image or additional information thereabout. Referring to FIG. 18, data F added to page 3, which is performed last in the firmware update process, are deleted, and data C, which are backed up in FIG. 17, are copied to page 3. Also, referring to FIG. 16 and FIG. 15, data D and data E are copied respectively to page 4 and page 5. Referring to FIG. 14, data E, which were copied to page 6, are deleted, whereby restoration of the previous version of firmware may be performed. Here, the update completion information in the update status information is set to ‘in progress (0x01)’ during restoration, and is then set to ‘complete (0x00)’ when restoration is completed. Also, the page number of the restored page is stored, whereby, when a problem occurs during restoration, the update process for rolling back to the previous state may be performed. That is, after firmware has been updated with a new version of firmware using the overwrite-based update method, restoration of the previous version of firmware may be attempted. When the process of restoration of the previous version of firmware is interrupted, the firmware is again updated with the new version of firmware, and then restoration of the previous version of firmware is started again from the beginning, whereby the previous version of firmware may be restored.

Accordingly, even if an error occurs during the update process, the firmware update target device (200 in FIG. 1) may continue the update process using the update status information, thereby completing the update. Also, unlike the case illustrated in FIG. 12, even though the entire firmware image of the previous version is not present, the previous version of firmware may be restored using the new firmware image and the previously stored firmware update information and delta image.

Accordingly, through the method proposed by the present invention, even if the update process is interrupted, the update process may be resumed from the point at which the update was interrupted, whereby the update may be completed. Also, even if a request to revert to the previous version is made, restoration may be performed using the existing firmware update information and a backup of the delta image.

The above-described embodiment of the present invention may be implemented as program instructions executable by various computer devices, and may be recorded in computer-readable storage media. The computer-readable storage media may separately or collectively include program instructions, data files, data structures, and the like. The program instructions recorded in the media may be specially designed and configured for the embodiment, or may be available by being well known to computer software experts. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter. The above-mentioned hardware device may be configured such that it operates as one or more software modules in order to perform the operations of the embodiment, and vice-versa.

According to the present invention, through the apparatus and method for supporting firmware update, firmware update using a page-based delta image, which is created based on a page size of flash memory in the storage of a firmware update target device, is provided, whereby the efficiency of the process of creating a delta image for update and the efficiency of a firmware update process may be improved, and the amount of data to be transmitted may be reduced.

Also, through the apparatus and method for supporting firmware update, the present invention provides firmware update suitable for the state of the hardware resources of a firmware update target device, whereby firmware update may be performed not only in smart devices that are capable of storing a new version of a firmware image but also in low-specification smart devices.

Also, through the apparatus and method for supporting firmware update, the present invention provides firmware update in which, when firmware update is interrupted, update may be resumed from the point at which the update was interrupted, or the firmware may be restored to the state before the update. Accordingly, even if an update error occurs because a network connection is blocked or a smart device is turned off, it is possible to effectively respond thereto, whereby stability may be improved.

Also, through the apparatus and method for supporting firmware update, the present invention establishes a secure communication channel by performing mutual authentication during a firmware update process, and performs firmware update through signature verification or message authentication for a firmware image, whereby secure update that guarantees the integrity of firmware may be performed.

Although specific embodiments have been described in the specification, they are not intended to limit the scope of the present invention. For the conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

What is claimed is:

1. An apparatus for providing firmware update, comprising:
a state information analysis unit for analyzing device state information received from a firmware update target device and thereby acquiring information about a version of existing firmware and information about a storage unit of the firmware update target device;
an image creation unit for creating a delta image in units of pages based on a flash memory page size included in the information about the storage unit and on a difference between the existing firmware and new firmware;
an update information creation unit for creating update information in which an update method is specified; and
a communication unit for transmitting the update information and the delta image to the firmware update target device in order to update the existing firmware of the firmware update target device based on the update method.

2. The apparatus of claim 1, wherein the update method is selected from among an overwrite-based update method, in which an existing firmware image is overwritten with a new firmware image, and a copy-based update method, in which the existing firmware image is not overwritten with the new firmware image.

3. The apparatus of claim 2, wherein:
the copy-based update method is configured such that the new firmware image is written from a last page thereof to a new area of the storage unit of the firmware update target device; and
the overwrite-based update method is configured such that the new firmware image is written from the last page thereof to an area in which the existing firmware image is stored in the storage unit of the firmware update target device after pages to be overwritten with the new firmware image due to update, among pages included in the existing firmware image, are backed up in the new area of the storage unit of the firmware update target device.

4. The apparatus of claim 3, wherein the copy-based update method and the overwrite-based update method are configured to store update status information while firmware update is in progress and to use the update status information to resume firmware update from a page that was processed at a time of interruption or to revert to a state before update when firmware update is interrupted.

5. The apparatus of claim 4, wherein:
the copy-based update method is used when an amount of free space remaining in the storage unit of the firmware update target device is sufficient to store an image corresponding to the new firmware; and
the overwrite-based update method is used when the amount of free space remaining in the storage unit of the firmware update target device is insufficient to store the image corresponding to the new firmware.

6. The apparatus of claim 5, wherein:
the image creation unit creates multiple partial delta images, each of which has a size corresponding to the amount of the free space, when the amount of the free space remaining in the storage unit of the firmware update target device is insufficient to store the delta image; and
the communication unit transmits the update information and each of the partial delta images to the firmware update target device in order to update the existing firmware of the firmware update target device based on the update method.

7. The apparatus of claim 6, wherein the update information includes information for identifying the firmware update target device, new firmware version information, and the update method, and further includes delta information, which includes one or more of a total number of pages included in the delta image, a number of pages to be modified, page numbers of the pages to be modified, a location of data to be modified, a length of the data to be modified, a number of pages to be added, page numbers of the pages to be added, a length of data on a last page to be added, and an integrity verification value.

8. A firmware update target device, comprising:
a communication unit for transmitting device state information to a firmware update provision apparatus in order to enable the firmware update provision apparatus to acquire information about a version of existing firmware and information about a storage unit by analyzing the device state information and for receiving a delta image and update information, in which an update method is specified, from the firmware update provision apparatus, the delta image being created in units of pages based on a flash memory page size, which is included in the information about the storage unit, and on a difference between the existing firmware and new firmware; and
an update unit for updating firmware using the delta image based on the update method.

9. The firmware update target device of claim 8, wherein the update method is selected from among an overwrite-based update method, in which an existing firmware image is overwritten with a new firmware image, and a copy-based update method, in which the existing firmware image is not overwritten with the new firmware image.

10. The firmware update target device of claim 9, wherein:
the copy-based update method is configured such that the new firmware image is written from a last page thereof to a new area of the storage unit; and
the overwrite-based update method is configured such that the new firmware image is written from the last page thereof to an area in which the existing firmware image is stored in the storage unit after pages to be overwritten with the new firmware image due to update, among pages included in the existing firmware image, are backed up in the new area of the storage unit.

11. The firmware update target device of claim 10, wherein:
the update unit stores update status information; and
when update is interrupted, the update unit is capable of resuming update from a page that was processed at a time of interruption or of reverting to a state before the update using the update status information.

12. The firmware update target device of claim 11, wherein:
the copy-based update method is used when an amount of free space remaining in the storage unit is sufficient to store the new firmware image; and
the overwrite-based update method is used when the amount of free space remaining in the storage unit is insufficient to store the new firmware image.

13. The firmware update target device of claim 12, wherein:
the communication unit sequentially receives partitioned delta images, each of which is created by the firmware update provision apparatus so as to have a size corresponding to the amount of free space remaining in the storage unit because the amount of the free space is insufficient to store the delta image; and
the update unit sequentially performs partial update using the partitioned delta images, thereby completing full update.

14. The firmware update target device of claim 13, wherein the update information includes information for identifying the firmware update target device, new firmware version information, and the update method, and further includes delta information, which includes one or more of a total number of pages included in the delta image, a number of pages to be modified, page numbers of the pages to be modified, a location of data to be modified, a length of the data to be modified, a number of pages to be added, page numbers of the pages to be added, a length of data on a last page to be added, and an integrity verification value.

15. A firmware update method, comprising:
transmitting device state information to a firmware update provision apparatus in order to enable the firmware update provision apparatus to acquire information about a version of existing firmware and information about a storage unit by analyzing the device state information;
receiving a delta image and update information, in which an update method is specified, from the firmware update provision apparatus, the delta image being created in units of pages based on a flash memory page size, which is included in the information about the storage unit, and on a difference between the existing firmware and new firmware; and
updating firmware using the delta image based on the update method.

16. The firmware update method of claim 15, wherein the update method is selected from among an overwrite-based update method, in which an existing firmware image is overwritten with a new firmware image, and a copy-based update method, in which the existing firmware image is not overwritten with the new firmware image.

17. The firmware update method of claim 16, wherein:
the copy-based update method is configured such that the new firmware image is written from a last page thereof to a new area of the storage unit; and
the overwrite-based update method is configured such that the new firmware image is written from the last page thereof to an area in which the existing firmware image is stored in the storage unit after pages to be overwritten with the new firmware image due to update, among pages included in the existing firmware image, are backed up in the new area of the storage unit.

18. The firmware update method of claim 17, wherein updating the firmware is configured to store update status information, and when update is interrupted, the update status information is used to resume update from a page that was processed at a time of interruption or to revert to a state before the update.

19. The firmware update method of claim 18, wherein:
the copy-based update method is used when an amount of free space remaining in the storage unit is sufficient to store the new firmware image; and
the overwrite-based update method is used when the amount of free space remaining in the storage unit is insufficient to store the new firmware image.

20. The firmware update method of claim 19, wherein the update information includes information for identifying the firmware update target device, new firmware version information, and the update method, and further includes delta information, which includes one or more of a total number of pages included in the delta image, a number of pages to be modified, page numbers of the pages to be modified, a location of data to be modified, a length of the data to be modified, a number of pages to be added, page numbers of the pages to be added, a length of data on a last page to be added, and an integrity verification value.
